(19) United States
(12) Patent Application Publication
(10) Pub. No.: US 2005/0191393 A1
(43) Pub. Date: Sep. 1, 2005

(54) Food grade natural/organic method for treating food

(76) Inventors: James Postma, Chico, CA (US); Merritt C. Erickson, Orland, CA (US)

Correspondence Address: Donald W. Meeker;Patent Agent, 924 East Ocean Front #E, Newport Beach, CA, 92661, US

(21) Appl. No.: 10/922,065

(22) Filed: Aug. 19, 2004

Related U.S. Application Data
(63) Continuation-in-part of application No. 10/789,034, filed on Feb. 27, 2004.

(51) Int. Cl. A23L 1/30

(52) U.S. Cl. 426/324

(57) ABSTRACT

Foods, including produce, nuts, and meats are preserved and disinfected in a holding container by adding any of a variety of antioxidant acids and water to kill bacteria and ascorbic acid to hold the food.

### REFERENCES TO RELATED PATENT APPLICATION

This is a continuation-in-part application of utility patent application Ser. No. 10/789,034, filed Feb. 27, 2004.

### BACKGROUND OF THE INVENTION

1. Field of the Invention

The present invention relates to a method for holding food and specifically to a method for holding food and killing bacteria by adding water and acetic acid and/or any of a variety of antioxidant acids to fresh food in a container in a first step for killing bacteria and by adding ascorbic acid to the container in a second step for holding, which produces bruise-free foods of good color, flavor and texture.

2. Description of the Prior Art

Part of the food preservation process is to prevent a variety of “browning” processes that occur naturally after the foods are harvested or the meat cut. Many of these reactions are oxidations of the food material by oxygen that is present in that air and dissolved in the solution containing the food.

Holding food can be done with refrigeration, especially in transportation, but that is an energy consuming relatively expensive way to ship foods.

Using a mechanical harvester bruises or scars produce and the bruises and scars turn a dark color.

None of the prior art patents adequately address the problems of holding food for a long period (in some cases such as olives about two years) and maintaining the natural color of the food as well as preventing discoloring from bruises and scarring as well as avoiding the use of toxic substances and replacing them with healthy substances.

What is needed is a method of holding food, such as fruit and vegetables for a longer period of time and maintaining the natural color of the food as well as preventing discoloring of the food from bruises and scarring as well as avoiding the use of toxic substances and replacing them with healthy substances.

### SUMMARY OF THE INVENTION

An object of the present invention is to provide a method of adding water and acetic acid and/or one or more other antioxidant acids to fresh food to kill bacteria and adding ascorbic acid to hold the food or preserve food for a long period (for up to two years for some foods such as olives) and maintaining the natural color of the food as well as preventing discoloring of the food from bruises and scarring as well as avoiding the use of toxic substances, such as Sodium Benzoate, and replacing them with a healthy substance, such as ascorbic acid combined with the acetic acid and/or one or more other antioxidant acids with similar properties.

Another object of the method of the present invention is to replace the toxic Sodium Benzoate with a healthy substance Ascorbic Acid that adds Vitamin C for health and also acts as an antioxidant for better preserving the food.

One more object of the method of the present invention is to use Ascorbic Acid with food derivatives to add Vitamin C to them.

Yet another object of the present invention is to hold foods in a liquid solution with ascorbic acid and one or more antioxidant acids for transporting the foods rather than refrigerating them.

In brief, the present invention uses food grade natural and/or organic solutions for holding food as well as killing bacteria in the food. The present invention is utilized on any food item that needs to be held in the liquid for storage and transport instead of cold storage. During harvest time it will stop the browning of the fruit and vegetables and also stop the scarring after picking or harvesting. When it is used as a cleansing process or disinfectant/sanitizer to get off dirt, metals, bacteria and then it will hold its color longer and its freshness, before packaging or eating the food.

The method of the present invention for holding food as well as killing bacteria comprises, after placing the fresh food in a bag or any type of container, the first step comprises adding water and acetic acid or other antioxidant acid or combination of antioxidant acids. The second step comprises adding two tablespoons of ascorbic acid more or less per gallon of food at a pH of 3.2 or less, preferably 2.8, to the container to hold or preserve the food by stabilizing the food so that no bacteria will grow. Using the ascorbic acid performs the same function as Sodium Benzoate, but it will keep the food at its natural color and crisper for a longer period of time.

One of the well-studied properties of ascorbic acid is its use as an antioxidant. Ascorbic acid reacts readily with atmospheric and dissolved oxygen turning it into water. Many fruits and vegetables contain ascorbic acid naturally to protect themselves from oxidation, although olives do not. Other preservatives, such as sodium benzoate, BHT, and BHA have this same antioxidant property. Ascorbic acid is used in the present inventive method for its lack of toxicity and commercial acceptance.

An advantage of the method of the present invention is that it holds or preserves the olives and or other fruit and vegetables for a long time (up to at least two years) and maintains the green color of the olives.

Another advantage of the method of the present invention is that it prevents the discoloring of produce from bruises and scars.

An additional advantage of the method of the present invention is that it replaces a toxic substance with a non-toxic and very healthy substance, which contains Vitamin C so that it adds vitamin C to the olives and/or other produce an anti-oxidant so that it is more effective as a preservative.

Yet another advantage of the method of the present invention is that it inhibits the growth of bacteria in or around the foods.

One further advantage of the present invention is that it holds foods for transporting them rather than refrigerating them.

### BEST MODE FOR CARRYING OUT THE INVENTION

A method of preserving and killing bacteria in foods to maintain the natural color of the foods and prevent discoloration of the foods from bruising and scarring comprises:

a first step comprising adding a solution of water and at least one antioxidant acid at a pH of at most 3 to a container of food;

a second step comprising adding a quantity of ascorbic acid to the container.

The at least one antioxidant acid comprises one or more antioxidant acids taken from the list of antioxidant acids including sorbic acid, benzoic acid, ethyl phydroxybenzoate, propyl phydroxybenzoate, methyl phydroxybenzoate, sulphur diozide, biphenyl diphenyl, orthophenyl phenol, thiabendazole, nisin, natamycin, formic acid, hexamethylene, dimethyl dicarbonate, acetic acid, ammonium acetate, lactic acid, propionic acid, carbon dioxide, malic acid, fumaric acid, ascorbyl palmitate, ascorbyl stearate, tocopherols, alpha-,gamma-,delta-, propyl gallate, octyl gallate, dodecyl gallate, erythorbic acid, tert-butylHydroQuinone (TBHQ), butylated hydroxy-anisole(BHA), butylated hydroxy-toluene (BHT), lecithin, citric acid, tartaric acid, phosphoric acid, metatartaric acid, adipic acid, succinic acid, 1,4-Heptonolactone, niacin, 1-napthanoic, 2,4Dinitrophenol, 2-Napthanoic, nitrobenzoic, arsenic, bromoacetic, butanoic, chloroacetic, cupferron, cyanoacetic, D-tartaric, EDTA, glutamic, glutaric, glyoxylic, hypophosphorous, iodic, ketoglutaric, maleic, malonic, nicotinic, nitrous, oxalic, oxaloacetic, phenylacetic, phthalic, propenoic, pyrophosphoric, pyruvic, salicylic, thiocyanic, valeric, Vitamin C, Vitamin E, carotenoids and flavonoids.

Preferably the solution of water and acetic acid or other antioxidant acid has a pH of 2.8 or lower.

The quantity of antioxidant acid is two tablespoons of antioxidant acid per gallon of food.

The method of preserving and killing bacteria in foods to maintain the natural color of the foods and prevent discoloration of the foods from bruising and scarring may comprise:

placing a quantity of food in an acid solution of 5% antioxidant acid at a pH of at most 2.8 and 4% ascorbic acid.

Before usage, the method further comprises mixing the quantity of food and acid solution at 48% food and 52% acid solution for up to 12 days before distributing the food for use.

It is understood that the preceding description is given merely by way of illustration and not in limitation of the invention and that various modifications may be made thereto without departing from the spirit of the invention as claimed.

1. A method of preserving and killing bacteria in foods to maintain the natural color of the foods and prevent discoloration of the foods from bruising and scarring, the method comprising:
a first step comprising adding a solution of water and at least one antioxidant acid at a pH of at most 3 to fresh food in a container to kill bacteria;
a second step comprising adding a quantity of ascorbic acid to the container to hold the food.

2. The method of claim i wherein the at least one antioxidant acid comprises at least one antioxidant acid taken from the list of antioxidant acids including sorbic acid, benzoic acid, ethyl phydroxybenzoate, propyl phydroxybenzoate, methyl phydroxybenzoate, sulphur diozide, biphenyl diphenyl, orthophenyl phenol, thiabendazole, nisin, natamycin, formic acid, hexamethylene, dimethyl dicarbonate, acetic acid, ammonium acetate, lactic acid, propionic acid, carbon dioxide, malic acid, fumaric acid, ascorbyl palmitate, ascorbyl stearate, tocopherols, alpha-, gamma-, delta-, propyl gallate, octyl gallate, dodecyl gallate, erythorbic acid, tert-butylHydroQuinone (TBHQ), butylated hydroxy-anisole(BHA), butylated hydroxy-toluene (BHT), lecithin, citric acid, tartaric acid, phosphoric acid, metatartaric acid, adipic acid, succinic acid, 1,4-Heptonolactone, niacin, 1-napthanoic, 2,4Dinitrophenol, 2-Napthanoic, nitrobenzoic, arsenic, bromoacetic, butanoic, chloroacetic, cupferron, cyanoacetic, D-tartaric, EDTA, glutamic, glutaric, glyoxylic, hypophosphorous, iodic, ketoglutaric, maleic, malonic, nicotinic, nitrous, oxalic, oxaloacetic, phenylacetic, phthalic, propenoic, pyrophosphoric, pyruvic, salicylic, thiocyanic, valeric, Vitamin C, Vitamin E, carotenoids and flavonoids.

3. The method of claim 1 preferably wherein the solution of water and at least one antioxidant acid has a pH of 2.8.

4. The method of claim 1 wherein the quantity of antioxidant acid is two tablespoons of antioxidant acid per gallon of food.

5. A method of preserving and killing bacteria in foods to maintain the natural color of the foods and prevent discoloration of the foods from bruising and scarring, the method comprising:
placing a quantity of food in an acid solution of 5% antioxidant acid at a pH of at most 2.8 and 4% ascorbic acid.

6. The method of claim 5 wherein the at least one antioxidant acid comprises an antioxidant acid taken from the list of antioxidant acids including sorbic acid, benzoic acid, ethyl phydroxybenzoate, propyl phydroxybenzoate, methyl phydroxybenzoate, sulphur diozide, biphenyl diphenyl, orthophenyl phenol, thiabendazole, nisin, natamycin, formic acid, hexamethylene, dimethyl dicarbonate, acetic acid, ammonium acetate, lactic acid, propionic acid, carbon dioxide, malic acid, fumaric acid, ascorbyl palmitate, ascorbyl stearate, tocopherols, alpha-,gamma-,delta-, propyl gallate, octyl gallate, dodecyl gallate, erythorbic acid, tert-butylHydroQuinone (TBHQ), butylated hydroxy-anisole(BHA), butylated hydroxy-toluene (BHT), lecithin, citric acid, tartaric acid, phosphoric acid, metatartaric acid, adipic acid, succinic acid, 1,4-Heptonolactone, niacin, 1-napthanoic, 2,4Dinitrophenol, 2-Napthanoic, nitrobenzoic, arsenic, bromoacetic, butanoic, chloroacetic, cupferron, cyanoacetic, D-tartaric, EDTA, glutamic, glutaric, glyoxylic, hypophosphorous, iodic, ketoglutaric, maleic, malonic, nicotinic, nitrous, oxalic, oxaloacetic, phenylacetic, phthalic, propenoic, pyrophosphoric, pyruvic, salicylic, thiocyanic, valeric, Vitamin C, Vitamin E, carotenoids and flavonoids.

7. The method of claim 5 further comprising mixing the quantity of food and acid solution at 48% food and 52% acid solution for 12 days before distributing the food for use.
